(19) United States
(12) Patent Application Publication
(10) Pub. No.: US 2015/0344126 A1
(43) Pub. Date: Dec. 3, 2015

(54) METHOD FOR IMPROVING CROSSWIND STABILITY OF A PROPELLER DUCT AND A CORRESPONDING APPARATUS, SYSTEM AND COMPUTER READABLE MEDIUM

(71) Applicant: SINGAPORE TECHNOLOGIES AEROSPACE LTD, Paya Lebar (SG)

(72) Inventor: Keen Ian CHAN, Paya lebar (SG)

(21) Appl. No.: 14/760,278

(22) PCT Filed: Jan. 13, 2014
(86) PCT No.: PCT/SG2014/000006

§ 371 Date: Jul. 10, 2015

(30) Foreign Application Priority Data
Jan. 21, 2013 (SG) 201300494-0

(51) Int. Cl. B64C 11/00; B64C 27/20; F15D 1/02

(52) U.S. Cl. CPC B64C 11/001; F15D 1/02; B64C 27/20

(57) ABSTRACT

Various embodiments provide a method for improving crosswind stability of a propeller duct. The method comprises defining an initial duct section based on a predetermined airfoil section having an initial value of a geometric parameter such that the geometric parameter of a portion of the initial duct section has the initial value. The method also comprises determining fluid flow paths around the initial duct section when subject to a crosswind having a predetermined crosswind speed. The method further comprises varying the initial value of the geometric parameter of the initial duct section to a threshold value which causes separation of fluid flow paths at a windward side of the initial duct section at and above the predetermined crosswind speed to form an improved duct section. Various embodiments provide a corresponding apparatus, system and/or computer readable medium.

### TECHNICAL FIELD

Various embodiments relate to a method for improving crosswind stability of a propeller duct and a corresponding apparatus, system and computer readable medium.

### BACKGROUND

In helicopter-mode ducted propellers, it is known that the “bell-mouth” type of duct design is most advantageous for hover endurance. The well-rounded leading edge is effective in guiding air flow into the duct, free of flow separation. A well-known example is the VZ-1 Hiller “Flying Platform” of the 1950s.

However, such ducted propellers also have the inherent tendency to pitch away from the wind during hovering in a crosswind. This poses challenges for maintaining hover station during crosswind conditions.

Known techniques for improving crosswind stability have tended to involve installing some form of additional control mechanism, incurring added weight and complexity to the aircraft.

### SUMMARY

Various embodiments provide a method for improving crosswind stability of a propeller duct, the method comprising: defining an initial duct section based on a predetermined airfoil section having an initial value of a geometric parameter such that the geometric parameter of a portion of the initial duct section has the initial value; determining fluid flow paths around the initial duct section when subject to a crosswind having a predetermined crosswind speed; and varying the initial value of the geometric parameter of the initial duct section to a threshold value which causes separation of fluid flow paths at a windward side of the initial duct section at and above the predetermined crosswind speed to form an improved duct section.

In an embodiment, the portion of the initial duct section having the initial value of the geometric parameter is a leading edge portion of the initial duct section.

In an embodiment, a curvature of the leading edge portion of the initial duct section corresponds with a curvature of a leading edge portion of the predetermined airfoil section.

In an embodiment, a leading edge portion of the initial duct section comprises an airfoil portion having the same initial value of the geometric parameter as the predetermined airfoil section.

In an embodiment, determining fluid flow paths around the initial duct section when subject to a crosswind having a predetermined crosswind speed comprises determining a flow field.

In an embodiment, the threshold value causes attached fluid flow paths at the windward side at below the predetermined crosswind speed.

In an embodiment, varying the initial value of the geometric parameter of the initial duct section varies a curvature of a leading edge portion of the initial duct section, and the threshold value defines a specific curvature of the leading edge portion of the initial duct section.

In an embodiment, varying the initial value of the geometric parameter of the initial duct section increases the curvature of the leading edge portion of the initial duct section.

In an embodiment, the method further comprises determining fluid flow paths around the improved duct section at below the predetermined crosswind speed to determine that fluid flow paths are attached.

In an embodiment, the geometric parameter comprises a measure of curvature.

In an embodiment, the measure of curvature comprises a thickness to chord ratio.

In an embodiment, the method further comprises measuring the initial value of the geometric parameter of the predetermined airfoil section.

Various embodiments provide an apparatus comprising: at least one processor; and at least one memory including computer program code; the at least one memory and the computer program code configured to, with the at least one processor, cause the apparatus at least to: define an initial duct section based on a predetermined airfoil section having an initial value of a geometric parameter such that the geometric parameter of a portion of the initial duct section has the initial value; determine fluid flow paths around the initial duct section when subject to a crosswind having a predetermined crosswind speed; and vary the initial value of the geometric parameter of the initial duct section to a threshold value which causes separation of fluid flow paths at a windward side of the initial duct section at and above the predetermined crosswind speed to form an improved duct section.

In an embodiment, the apparatus further comprises a measuring device configured in use to receive geometric data of the predetermined airfoil section, the measuring device being adapted to determine the initial value of the geometric parameter of the predetermined airfoil section based on the received geometric data.

Various embodiments provide a system for improving crosswind stability of a propeller duct, the system comprising: means for defining an initial duct section based on a predetermined airfoil section having an initial value of a geometric parameter such that the geometric parameter of a portion of the initial duct section has the initial value; means for determining fluid flow paths around the initial duct section when subject to a crosswind having a predetermined crosswind speed; and means for varying the initial value of the geometric parameter of the initial duct section to a threshold value which causes separation of fluid flow paths at a windward side of the initial duct section at and above the predetermined crosswind speed to form an improved duct section.

In an embodiment, the system further comprises means for receiving geometric data of the predetermined airfoil section and determining the initial value of the geometric parameter of the predetermined airfoil section based on the received geometric data.

Various embodiments provide a computer readable storage medium having stored thereon computer program code for instructing a computer processor to execute a method for improving crosswind stability of a propeller duct, the method comprising: defining an initial duct section based on a predetermined airfoil section having an initial value of a geometric parameter, the geometric parameter of a portion of the initial duct section having the initial value; determining fluid flow paths around the initial duct section when subject to a crosswind having a predetermined crosswind speed; and varying the initial value of the geometric parameter of the initial duct section to a threshold value which causes separation of fluid flow paths at a windward side of the initial duct section at and above the predetermined crosswind speed to form an improved duct section.

It is to be understood that the above-mentioned further features of the above-mentioned method are equally applicable and are hereby restated in respect of the above-described apparatus, system and computer readable medium.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a flowchart illustrating a method for improving crosswind stability of a propeller duct in accordance with an embodiment;

FIG. 2 is a cross section view of an initial duct section in accordance with an embodiment;

FIG. 3 illustrates flow fields for the initial duct section of FIG. 2 when subjected to a crosswind of 10 Knots, wherein FIG. 3a illustrates a windward leading edge portion and FIG. 3b illustrates a leeward leading edge portion;

FIG. 4 illustrates pressure contours of the embodiment of FIG. 3;

FIG. 5 is a cross section view of an improved duct section in accordance with an embodiment;

FIG. 6 illustrates flow fields at the windward leading edge portion of the improved duct section of FIG. 5 when subjected to a crosswind of 10 Knots;

FIG. 7 illustrates flow fields at the windward leading edge portion of the improved duct section of FIG. 5 at static hover, that is, when subjected to no crosswind;

FIG. 8 is a graph of static thrust against propeller rpm for both the initial duct section of FIG. 2 and the improved duct section of FIG. 5;

FIG. 9 is a block diagram of a system for improving crosswind stability of a propeller duct in accordance with an embodiment; and,

FIG. 10 is a block diagram of a computer system for implementing a method for improving crosswind stability of a propeller duct, in accordance with an embodiment.

### DETAILED DESCRIPTION

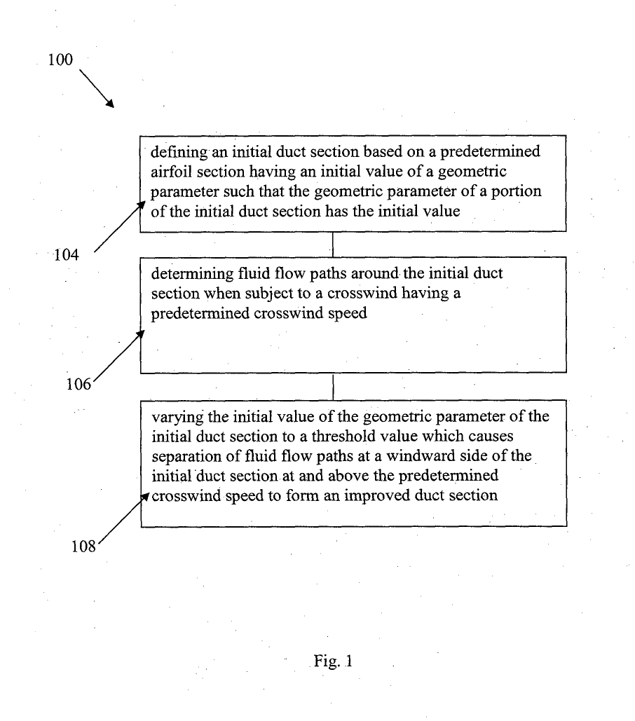

FIG. 1 shows a flow diagram 100 illustrating a method for improving crosswind stability of a propeller duct in accordance with an embodiment.

At 104, an initial duct section may be defined based on a predetermined airfoil section. The predetermined airfoil section may have an initial value of a geometric parameter. Accordingly, the initial duct section may be defined such that the same geometric parameter of a portion of the initial duct section also has the initial value.

In an embodiment, defining the initial duct section includes defining the aforementioned portion to correspond with the predetermined airfoil section so that the two elements share the same geometric parameter value. In an embodiment, the aforementioned portion of the initial duct section includes a leading-edge portion. In an embodiment, the leading edge portion comprises an airfoil section (or a portion which resembles an airfoil), wherein a value of the geometric parameter of this airfoil section has the initial value. In this way, a curvature of the leading edge portion may correspond to a curvature of a leading edge portion of the predetermined airfoil section. Accordingly, the initial duct section may be defined based on the predetermined airfoil section.

In an embodiment, the predetermined airfoil section may have a geometry which is optimal for hovering. Accordingly, the initial duct section, being defined based on the predetermined airfoil section, may inherit a geometry which is optimal for hovering, such as, that of the VZ-1 Hiller “Flying Platform”. To assist in the later analysis, the definition of the initial duct section specifies a geometric parameter of the initial duct section for enabling the geometry (e.g. curvature) of a portion (e.g. a leading edge portion) to be varied in subsequent modifications. Hereinafter, the airfoil section which is used as a basis for generating the initial duct section is referred to as the “predetermined airfoil section” or the “basis airfoil”.

At 106, aerodynamic analysis may be performed based on the initial duct section. Specifically, fluid flow paths around the initial duct section when the initial duct section is subjected to a crosswind of a predetermined speed may be determined. In an embodiment, these fluid flow paths may be determined via wind tunnel tests of the physical initial duct section. In another embodiment, computer analysis may be performed on a computer model of the initial duct section to determine the fluid flow paths. Further, fluid flow paths may be determined using some other mathematical, numerical and/or graphical method. In an embodiment, a flow field may be generated in order to determine the fluid flow paths. The predetermined crosswind speed may be a crosswind speed which is expected to occur during normal operation of the propeller duct, for example, during normal hovering or motion of the duct.

At 108, the initial duct section may be modified to form an improved duct section. Specifically, the geometric parameter of the initial duct section may be varied to a threshold value which causes separation of fluid flow paths at a windward side of the initial duct section at and above the predetermined crosswind speed. The windward side may be a side of the initial duct section which is upwind from the rest of the initial duct section. In an embodiment, the value (i.e. threshold value) of the geometric parameter after the step of varying may cause flow separation (i.e. non-coherent flow) at a windward side at and above the predetermined crosswind speed. In an embodiment, this value (i.e. threshold value) of the geometric parameter may also cause no flow separation (i.e. cause attached or coherent flow) at the windward side at any crosswind speed below the predetermined crosswind speed. Accordingly, the step of varying may be performed to determine a threshold value at which point flow separation just starts to occur at the windward side at and above the predetermined crosswind speed.

As mentioned above, in an embodiment, the predetermined airfoil section may be selected based on its geometry. Specifically, the geometry may be such that when the initial duct section is defined based on the predetermined airfoil section, the initial duct section provides optimal hover performance in the absence of a cross wind. For example, the geometry may be optimal for generating a coherent flow of air through the duct. In an embodiment, a curvature of a leading edge portion of the predetermined airfoil section may be used to define an initial duct section having a leading edge portion with a corresponding curvature. In another embodiment, however, the predetermined airfoil section may be any generic airfoil shape, such as, for example, a Clark Y profile section. In a further embodiment, the predetermined airfoil section may be any airfoil shape.

In any case, once the predetermined airfoil section has been obtained, an initial duct section may be defined based on the predetermined airfoil section. The following describes how this may be done in accordance with an embodiment.

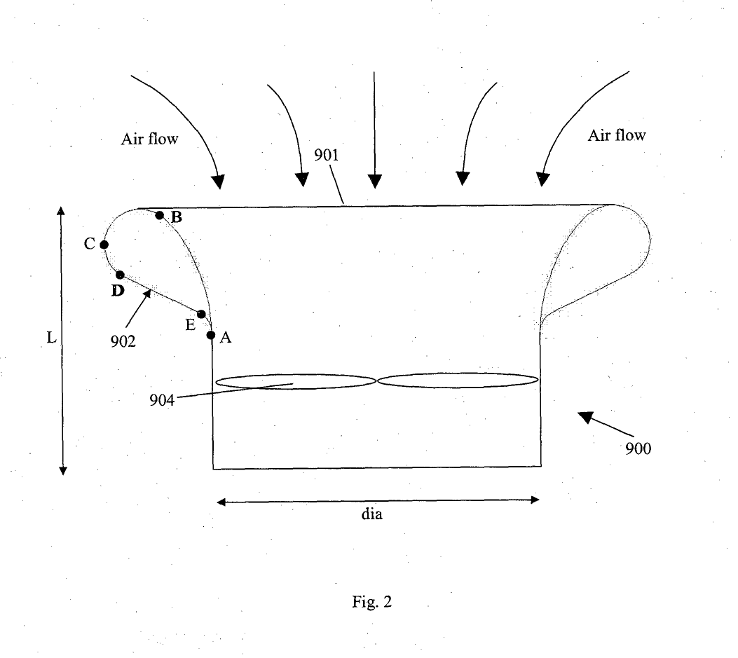

FIG. 2 shows a cross-section of an initial duct section 900 in hover, having a leading edge 901. The initial duct section 900 may include a leading edge portion 902. A cross-section of the leading edge portion 902 may be generated from a basis airfoil and, therefore, may resemble an airfoil section at least in part. The leading edge portion 902 may be considered a bell-mouth portion of the initial duct section 900. The leading edge portion 902 may initially be defined on the basis of hovering considerations only, i.e. without considering the effects of crosswind. The initial duct section may be configured in use to operate with a propeller 904.

Specifically, the leading edge portion 902 may be broken down into sub sections, as indicated in FIG. 2 by the reference signs A, B, C, D and E. The segment ABC may be set to correspond to part of the abovementioned predetermined airfoil section, such as, for example, a leading edge portion of the predetermined airfoil section. The nature of the correspondence may be that the curvatures substantially match. Additionally or alternatively, the physical scale of the sections may match.

In an embodiment, the predetermined airfoil section may be determined as described above. In another embodiment, the predetermined airfoil section may be any airfoil section with the leading edge region (i.e. a region corresponding to BC in FIG. 2) modified using a circular arc. In any case, the predetermined airfoil section may have a specific thickness to chord ratio, for example, 22%. The predetermined airfoil section may be chosen to provide good or optimal hover performance when applied to propeller ducts. In this way, the initial duct section may be designed with only hover in mind, i.e. without considering crosswind.

Once the section ABC has been defined as described above, the circular arc BC may be extended to D. In this way, the curvature of the portion BC may be extended to a further point D. Accordingly, the curvature of the portion BCD may be constant. Alternatively, the curvature of portion AB may be different from that of portion BCD.

Once the section ABCD has been defined as described above, a straight line may be drawn from D to E. Finally, a fillet (i.e. a curved section) may be used to connect E to A. In this manner, the complete leading edge portion 902, i.e. ABCDEA, may be defined.

The following describes in greater detail how points A to E, the fillet and other duct geometry may be defined:

The diameter (FIG. 2: dia) of the initial duct section may be established through mission profile considerations, i.e. the intended purpose of the duct may influence the diameter size. For example, for an unmanned aerial vehicle (UAV) application, the duct diameter is likely to be smaller than for a passenger or civil aircraft application. For example, application specific physical or geometrical constraints may apply (e.g. a need to fit the duct into a backpack in the case of a portable vertical take-off and landing (VTOL) UAV). In an embodiment, the initial duct section may be suitable for use with a Honeywell T-Hawk VTOL UAV and may have a diameter of about 350 mm.

The axial length (L) of the initial duct section may be sufficiently long to ensure that the propeller slipstream follows the duct diameter. If the axial length is too short, the slipstream may contract like an unducted propeller and cause aerodynamic inefficiencies. In an embodiment, the axial length may be equal to or greater than about half the duct diameter. In an embodiment, the initial duct section may be suitable for use with a Honeywell T-Hawk VTOL UAV and may have an axial length of about 175 mm.

The axial length between leading edge 901 and A may be equal to the chordwise length between the leading edge and maximum thickness point of the basis airfoil. This is the portion of the basis airfoil that is used, with the suction side facing into the duct, and would account for points A, B and C.

The points D, E and fillet EA may be defined for reasonable closure of the shape of the duct section. Stated differently, points D, E and fillet EA may be defined to result in a closed section comprising a collection of curves which blend smoothly with each other.

Since section ABCDEA is at least in part based on the predetermined airfoil section, the section ABCDEA has a corresponding geometry to that of the predetermined airfoil section. Also, the shape of the section ABCDEA can be seen to closely resemble an airfoil section, at least in part. Accordingly, the cross sectional shape (i.e. ABCDEA) of the leading edge portion 902 may closely resemble a cross sectional shape of the predetermined airfoil section.

In view of the above, a geometric parameter of the predetermined airfoil section may have the same value as the same geometric parameter of the leading edge portion 902. In other words, a geometric parameter of the cross section shape ABCDEA (which closely resembles an airfoil, at least in part) may have the same value as the same geometric parameter of the predetermined airfoil. In an embodiment, the geometric parameter is a measure of curvature, for example, a thickness to chord ratio. Accordingly, a thickness to chord ratio of the predetermined airfoil section (e.g. 22%) may be the same as a thickness to chord ratio of the leading edge portion 902. In this way, the leading edge portion 902 has a corresponding geometry to that of the predetermined airfoil section. Accordingly, the initial duct section 900 has a corresponding geometry to that of the predetermined airfoil section.

The initial duct portion 900 may be based on the predetermined airfoil section as described in the above with reference to ABCDEA of FIG. 2. However, in some other embodiments, the initial duct portion may be based on the predetermined airfoil section using another method. For example, the cross section of the leading edge portion (i.e. the portion which resembles an airfoil) may have a corresponding shape to that of the predetermined airfoil section. In another embodiment, only the shape of the leading edge portion of the initial duct section may be set to correspond, or precisely match, the shape of leading edge portion of the predetermined airfoil section. For example, the correspondence or matching could relate to the respective curvatures of the leading edge portion and predetermined airfoil section. Therefore, in summary, a leading edge portion of the initial duct section may have a corresponding or matching curvature to a leading edge portion of the predetermined airfoil.

It is to be understood that in some embodiments, a different parameter may be used to define the predetermined airfoil section and the initial duct section, i.e. other than the thickness to chord ratio. In any case, however, the parameter should enable the curvature of the initial duct section and, more specifically, the leading edge portion thereof to be modified or controlled.

Once the leading edge portion 902 of the initial duct section 900 has been defined, the remainder of the initial duct section is defined based on the leading edge portion 902. For example, the axial length and diameter of the duct may be defined as described above.

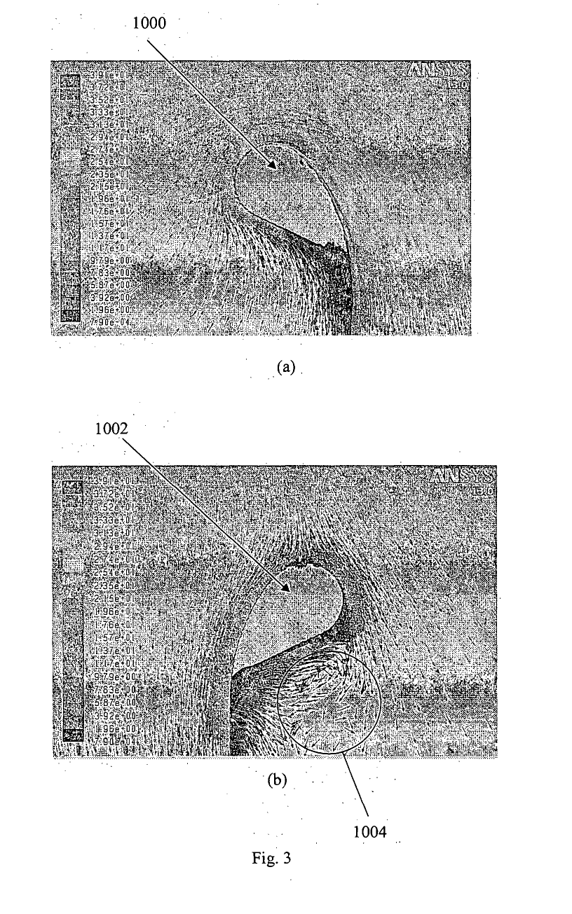

FIGS. 3a and 3b illustrate fluid flow paths around the initial duct section 900 when the initial duct section 900 is subjected to a crosswind at a predetermined speed, such as, for example, 10 knots. In FIGS. 3a and 3b the crosswind is from left to right. FIG. 3a illustrates fluid flow paths around a windward leading edge portion 1000 of the initial duct section 900, whereas FIG. 3b illustrates fluid flow paths around a leeward leading edge portion 1002 of the initial duct section 900. In an embodiment, the fluid flow paths may be visualized by generating computational fluid dynamics (CFD) simulations using FLUENT. However, in some other embodiments, different simulation packages may be used, for example, CFX, Numeca, etc. Additionally, in some other embodiments, the fluid flow paths around the initial duct section 900 may be determined using methods other than computer modelling methods. For example, fluid flow may be determined via a wind tunnel or via mathematical or tabular analysis. Such analysis may be manual or automated.

Due to the crosswind, there may be a significant suction pressure on the leading edge of the windward side 1000 of the initial duct section 900. This is evident from FIGS. 3a and 3b, wherein it can be seen that flow separation is occurring at the leeward side 1002, but not at the windward side 1000. Flow separation is indicated in FIG. 3b by region 1004. This suction pressure is stronger than that at the leeward side. Accordingly, a lift force caused by the initial duct section 900 at its windward side 1000 may be greater than a lift force caused by the initial duct section 900 at its leeward side 1002. This disparity between lifting forces may cause the initial duct section 900 to pitch (i.e. rotate or turn) away from the wind. In turn, this pitching movement may make it difficult for the initial duct section 900 to maintain hover station. Stated differently, the initial duct section 900 may not be able to remain in static hover horizontal (i.e. parallel) with respect to the ground.

A reason for the above identified effect may be as follows. The bell-mouth of the initial duct section 900 may be designed to be effective at guiding fluid (e.g. air) flow into the duct, i.e. it is designed for efficient hovering rather than for crosswind stability. Accordingly, fluid flow through the duct is attached and free of flow separation, enabling both the duct and the propeller to produce thrust efficiently. In turn this may improve aerodynamic efficiency during hovering. However, the characteristic of the duct which promotes attached flow and its associated advantages can also cause the duct to pitch away from the wind during crosswind. As seen more particularly on FIGS. 3a and 3b, as flow gets sucked into the duct from all directions, the cross-wind can inherently add to and increase local velocities at the windward side 1000 of the duct leading edge, and vice-versa at the leeward side 1002. With flow being guided into the duct at higher speeds at the windward side 1000, this region has greater suction pressure than the leeward side 1002. The resulting asymmetry in the pressure field can result in a pitching moment away from the wind.

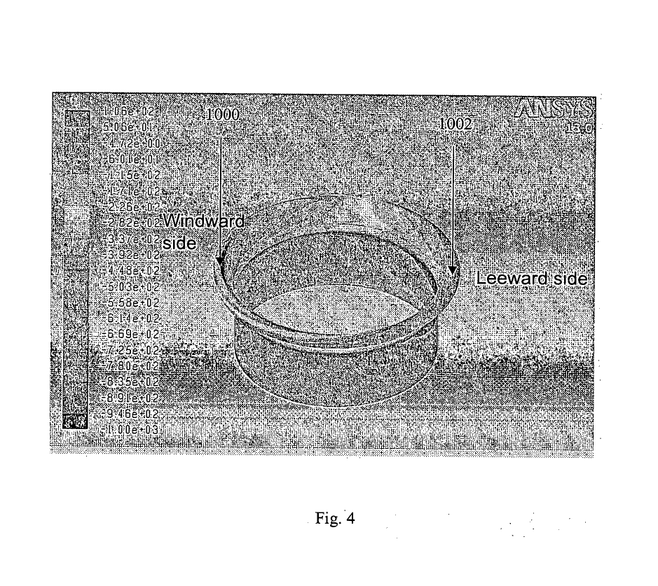

FIG. 4 illustrates pressure contours on the initial duct section 900, indicating that there can be a significant suction pressure on the windward side 1000. The significant suction pressure contours on the windward side 1000 can mean that the initial duct section 900 has a tendency to pitch away from the wind. In turn, this can make it difficult for the initial duct section 900 to maintain hover position.

As described above with reference to FIG. 2, the geometric parameter which controls the curvature of the leading edge 902 of the initial duct section 900 may be varied in order to vary the curvature of the initial duct section 900. In an embodiment, the geometric parameter may be varied to increase curvature, for example, it may be varied to increase the curvature of the leading edge portion BC of 902 in the region ABCD. Specifically, the geometric parameter may be varied in order to increase curvature of the initial duct section 900 until flow separation around the leading edge portion 902 on the windward side 1000 (FIG. 3) is achieved at the predetermined crosswind speed. In an embodiment, the thickness-to-chord ratio of the basis airfoil relating to segment ABC in FIG. 2 may be gradually varied, for example, reduced. The gradual varying on this parameter may stop just at the point when flow separation occurs at the windward side at the predetermined crosswind speed. The varying can be controlled manually or automatically. For example, when fluid flow paths are determined mathematically, the geometric parameter may be varied by a processor until the processor identifies that the condition of flow separation becomes true. Alternatively, in a manual embodiment, a human user may inspect a flow field and vary the geometric parameter until flow separation is visible in the flow field.

In the present example, the geometric parameter is the thickness-to-chord ratio of the basis airfoil. The starting value is 22%. At this starting value, the windward side 1000 may not cause noticeable flow separation when the initial duct section 900 is subjected to the predetermined crosswind speed (e.g. 10 knots). Accordingly, the geometric parameter may be varied until the point at which flow separation occurs at the windward side 1000, i.e. the parameter may be reduced until a threshold value is reached. Computational fluid dynamics (CFD) simulations may be performed to show that at the predetermined crosswind speed (e.g. 10 knots) a threshold of the thickness-to-chord ratio at which flow separation just begins to occur at the windward side is about 12%. Above this final value of 12%, flow separation may occur at the windward side 1000 only at crosswind speeds above the predetermined crosswind speed. Below this final value of 12%, flow separation may occur at the windward side 1000 at below the predetermined crosswind speed.

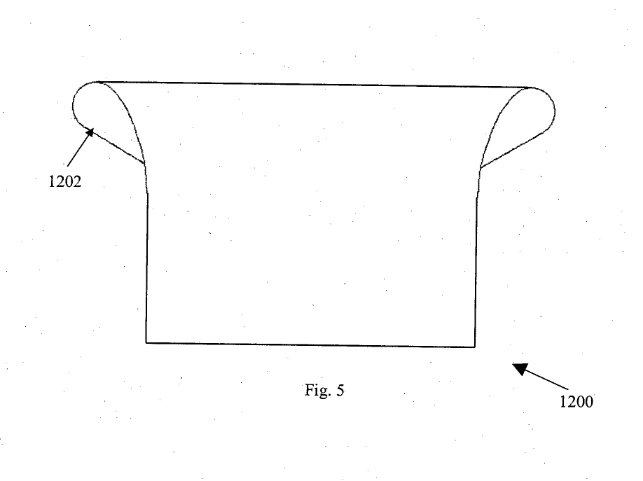

FIG. 5 shows the improved duct section 1200, with crosswind considered. The geometric parameter is now at its threshold value for the predetermined crosswind speed of 10 knots in this example. Compared to the initial duct section 900 (FIG. 2) the improved design 1200 has a smaller and more compact bell-mouth shape at the leading edge portion 1202. Stated differently, the leading edge portion of the improved duct section 1200 may have greater curvature. As mentioned above, the initial duct section 900 was designed with only hover performance in mind, crosswind was not considered. However, the improved duct section 1200 was designed with both hover and crosswind stability in mind.

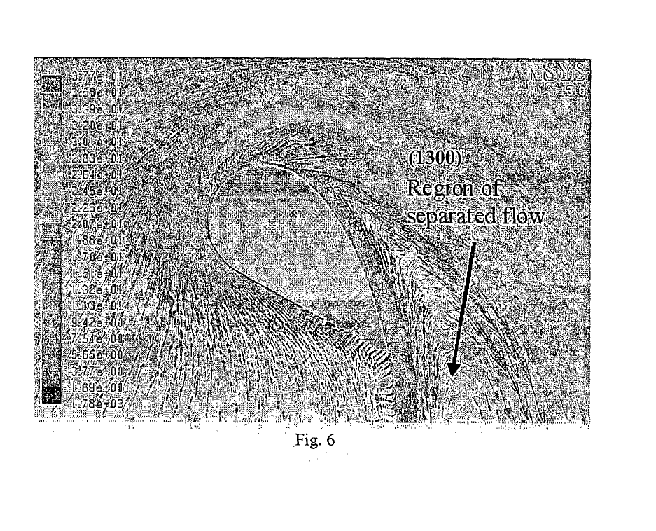

FIG. 6 illustrates CFD simulations of the improved duct section 1200. Visualizations of the streamlines in the vicinity of the windward part of the duct at the predetermined crosswind speed (e.g. 10 knots) demonstrate the accomplishment of the design intent: flow separation at region 1300, i.e. the windward side of the leading edge portion of the improved duct section 1200. It is noted that the crosswind is from left to right with respect to FIG. 6.

Accordingly, at the predetermined crosswind speed, the improved duct section 1200 is designed to cause flow separation at the windward side. Accordingly, the windward side of the improved duct section 1200 may generate less lift than the windward side of the initial duct section 900 at the predetermined crosswind speed. However, as mentioned above, the initial duct section 900 had a tendency to pitch away from the wind when subjected to the predetermined crosswind. This undesirable pitching movement was caused by a disparity between the lift at the windward and leeward sides of the initial duct section 900. This lift disparity was caused because local flow velocities were higher, giving rise to higher suction pressures, at the windward side as compared to the leeward side.

Now considering the improved duct section 1200, since flow separation occurs at the windward side, the lift at the windward side is reduced. Accordingly, the lift at the windward side is closer to the lift at the leeward side. Therefore, the improved duct section has less of a tendency to pitch away from the wind. Stated differently, the improved duct section 1200 is more stable in a crosswind having the predetermined speed compared to the initial duct section 900. Specifically, with the improved duct section 1200, the pitching moment is found to be a 46% less than with the initial duct section 900.

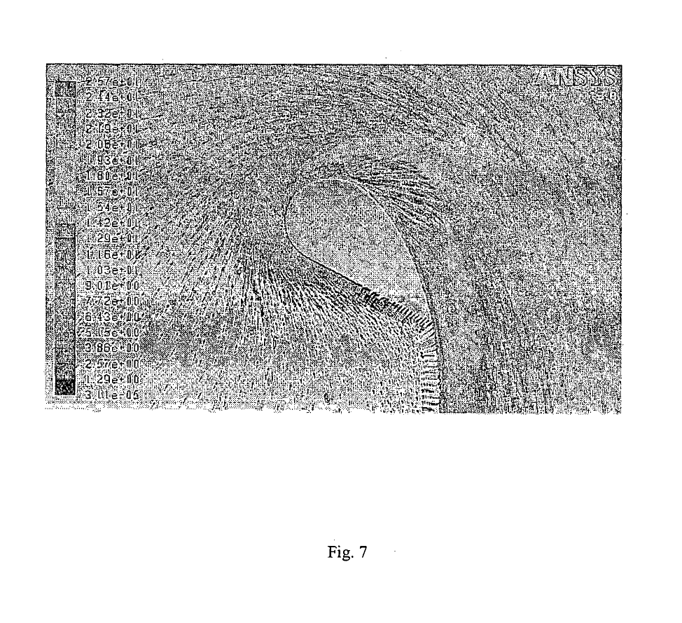

The above-described analysis of the improved duct section has focussed on its performance during a crosswind of the predetermined speed. FIG. 7 illustrates the fluid flow around the leading edge portion 1202 of the improved duct section 1200 when at hover without any crosswind. It can be seen that the incoming flow is free of flow separation, i.e. fluid flow paths remain attached to the duct wall. Thus, aerodynamic efficiency at hover without a crosswind has not been significantly affected. Stated differently, hover endurance of the improved duct section 1200 is substantially the same as the initial duct section 900. Therefore, the substantial improvement in crosswind stability is achieved without compromising hover endurance.

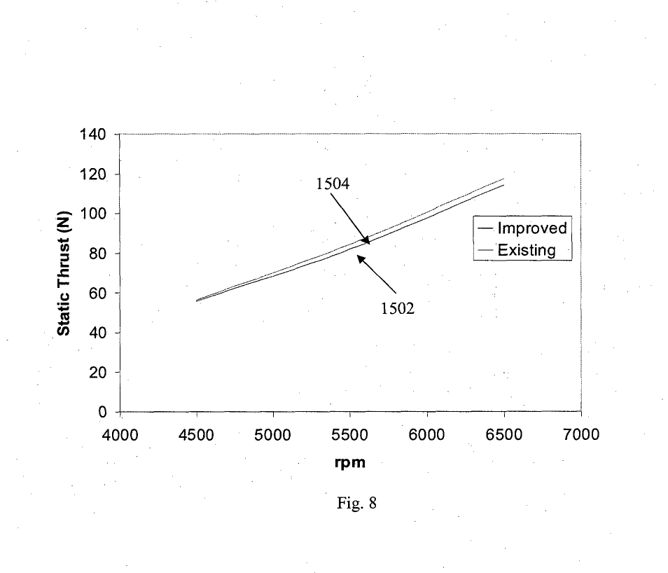

FIG. 8 graphically plots static thrust versus propeller rpm for both the improved duct section 1502 and the initial duct section 1504. FIG. 8 illustrates operation during hover and without any crosswind. It can be seen from FIG. 8 that compared to the initial duct section aerodynamic efficiency at hover without a crosswind of the improved duct section is slightly reduced. However, the reduction in no crosswind hover performance is very small compared to the large improvement in crosswind stability.

In the above-described embodiments, duct shaping may be used to produce flow separation as a means to improve crosswind stability without adding weight and complexity, or significantly compromising hover endurance. In aeronautics, flow separation is usually associated with an undesirable phenomenon to be avoided, for example, the loss of aerodynamic lift when an aircraft wing stalls, the loss of thrust and damage to jet engines when a compressor surges, etc. Rarely is flow separation deliberately sought after and designed for in aerodynamic devices, such as, primary aerodynamic components like propeller ducts. Accordingly, the deliberate design of a primary aerodynamic component for flow separation has a surprising beneficial aerodynamic effect.

According to the above-described embodiments, crosswind stability has been improved without the need for additional control mechanisms. This is advantageous since such additional control mechanisms add weight and complexity to an aircraft. In turn, this can increase fuel consumption and cost.

According to the above-described embodiments, the improvements in crosswind stability do not significantly reduce aerodynamic efficiency of the duct design when hovering in no crosswind. Therefore, crosswind stability is not provided at the cost of aerodynamic efficiency.

An additional advantage of the above-described embodiments is that the improved duct section 1200 (which is designed for both hover and crosswind performance) is smaller than the initial duct section 900 (which is designed for hover performance only). Therefore, the compactness of the propeller duct is improved, particularly if the application is for VTOL UAVs which need to be stored in a container or backpack to be brought into the field. The actual weight of the duct can also be reduced and in this way, fuel efficiency can also be improved.

In the above-described embodiments, the undesirable pitching moment is reduced by a substantial 46% over an initial design. Specifically, the bell-mouth duct is designed to reduce the suction pressure at the windward side, and hence the undesirable pitching moment, by being shaped to produce flow separation upon contact with a crosswind, while still maintaining separation-free flow conditions at hover without crosswind. Hence, there is virtually no compromise in the contribution of duct aerodynamics to hover endurance, i.e. the improved design functions as well under a no crosswind condition.

In the above-described embodiments, the geometric parameter used to define the initial duct section and used to modify the initial duct section into the improved duct section was the thickness to chord ratio of the basis airfoil. In some other embodiments, one or more other geometric parameters may be used. For example, the basis airfoil could be described by a number of spline curves, and the controlling parameters of these splines could be the geometric parameters.

In the above-described embodiments, the predetermined crosswind speed was 10 knots from left to right. However, in some other embodiments, the predetermined crosswind speed may have a different speed and/or direction. For example, the speed may be more or less than 10 Knots, such as, 8 Knots, 6 Knots, 4 Knots, 2 Knots, 12 Knots, 14 Knots, 16 Knots, 18 Knots, etc. Also, the crosswind may have a different horizontal direction (e.g. right to left) and/or may include a vertical component.

In an embodiment, the initial duct section and/or improved duct section may comprise all or only part of a complete propeller duct. For example, the duct section may only include the leading edge portion, or it may include all aspects between the leading and trailing edges.

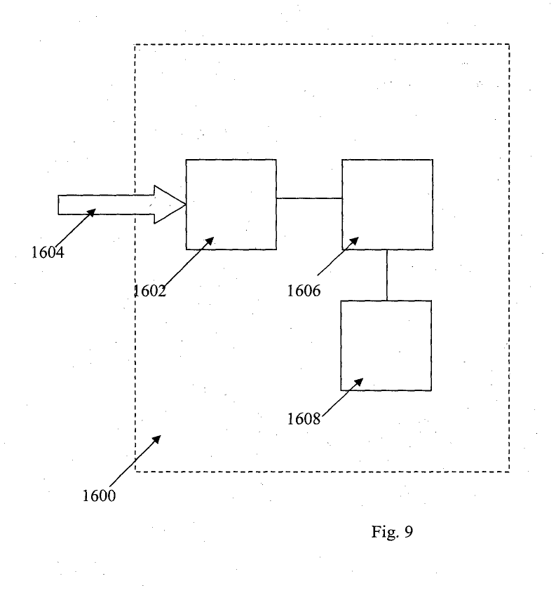

FIG. 9 is a schematic block diagram illustrating a system 1600 for improving crosswind stability of a propeller duct.

The system 1600 may comprise an input unit 1602 (e.g. a keyboard) for receiving input of geometric data relating to the predetermined airfoil section. The system 1600 may be adapted to determine the initial value of the geometric parameter of the predetermined airfoil section based on the received geometric data. In an embodiment, the geometric data may include various characteristics of the predetermined airfoil section, such as, for example, a thickness or a chord length. In another embodiment, the input unit 1602 may be configured to receive the geometric parameter (e.g. a thickness to chord ratio) of the predetermined airfoil section. In an embodiment, the input unit 1602 may be configured to receive other duct parameters, such as, for example, a duct diameter and/or a duct axial length.

The system 1600 may further comprise a processing unit 1606 (with at least one processor) coupled to the input unit 1602 for defining an initial duct section based on the predetermined airfoil section. The definition process may be such that the abovementioned geometric parameter of a portion of the initial duct section may have the initial value of the predetermined airfoil section. The processing unit 1606 may be additionally capable of conducting aerodynamic analysis. Specifically, the processing unit 1606 may be capable of determining fluid flow paths around the initial duct section at a predetermined crosswind speed. For example, the system 1600 may further comprise a display unit 1608 (e.g. a monitor screen) coupled to the processing unit 1606 for visualizing fluid flow paths around the initial duct section at the predetermined crosswind speed. However, in another embodiment, flow paths may be determined mathematically and displayed in numerical or tabular form (or not displayed at all). The processing unit 1606 may be further capable of varying the initial value of the geometric parameter of the initial duct section to cause separation of fluid flow paths at a windward side of the initial duct section at and above the predetermined crosswind speed to form an improved duct section. The final value of the geometric parameter may be determined graphically by a user viewing the display unit 1608 or numerically by the processing unit 1606 (i.e. without a user).

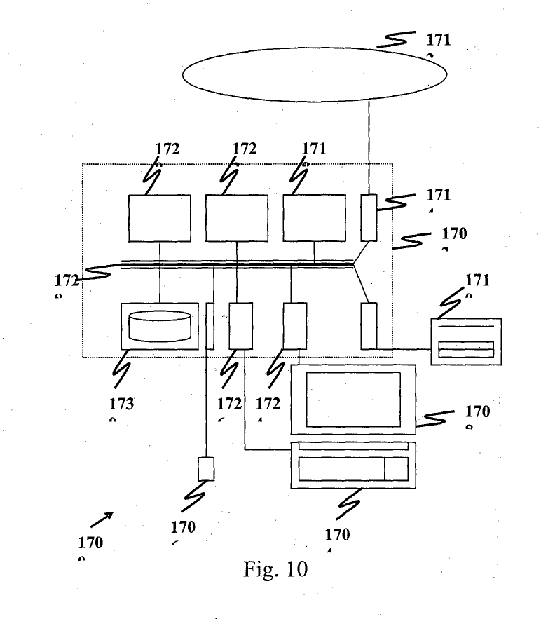

The method and system of an embodiment can be implemented on a computer system (i.e. apparatus) 1700, schematically shown in FIG. 10. It may be implemented as software, such as a computer program being executed within the computer system 1700, and instructing the computer system 1700 to conduct the method of the example embodiment.

The computer system 1700 comprises a computer module 1702, input modules such as a keyboard 1704 and mouse 1706 and a plurality of output devices such as a display 1708, and printer 1710.

The computer module 1702 is connected to a computer network 1712 via a suitable transceiver device 1714, to enable access to e.g. the Internet or other network systems such as Local Area Network (LAN) or Wide Area Network (WAN).

The computer module 1702 in the example includes a processor 1718, a Random Access Memory (RAM) 1720 and a Read Only Memory (ROM) 1722. The computer module 1702 also includes a number of Input/Output (I/O) interfaces, for example I/O interface 1724 to the display 1708, and I/O interface 1726 to the keyboard 1704.

The components of the computer module 1702 typically communicate via an interconnected bus 1728 and in a manner known to the person skilled in the relevant art.

The application program is typically supplied to the user of the computer system 1700 encoded on a data storage medium such as a CD-ROM or flash memory carrier and read utilising a corresponding data storage medium drive of a data storage device 1730. The application program is read and controlled in its execution by the processor 1718. Intermediate storage of program data may be accomplished using RAM 1720.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

It will be appreciated that a system for improving crosswind stability of a propeller duct may be provided whereby steps of example embodiments, such as, measuring an initial value of a geometric parameter of a predetermined airfoil section, defining an initial duct section based on a predetermined airfoil section, modifying the airfoil section at the leading edge of a propeller duct, etc., are automated. For example, in one implementation, one or more compartments for automated holding of the propeller duct, measuring the airfoil section at the leading edge of the propeller duct and modifying the propeller duct may be provided. Automating the steps may include using laser scanning, using a coordinate-measuring machine (CMM) and a computer numerical control (CNC) machine etc. In an embodiment, rapid prototyping may be utilized to form one or more initial or improved duct sections for testing their performance in crosswind conditions or no crosswind conditions.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for improving crosswind stability of a propeller duct, the method comprising:
defining an initial duct section free of added flow controllers based on a predetermined airfoil section having an initial value of a geometric parameter such that the geometric parameter of a portion of the initial duct section has the initial value;
determining fluid flow paths around the initial duct section when subject to a crosswind having a predetermined crosswind speed; and
varying the initial value of the geometric parameter of the initial duct section to a threshold value which causes separation of fluid flow paths at a windward side of the initial duct section at and above the predetermined crosswind speed to form an improved duct section corresponding to the predetermined crosswind speed.

2. The method as claimed in claim 1, wherein the portion of the initial duct section having the initial value of the geometric parameter is a leading edge portion of the initial duct section.

3. The method as claimed in claim 2, wherein a curvature of the leading edge portion of the initial duct section corresponds with a curvature of a leading edge portion of the predetermined airfoil section.

4. The method of claim 1, wherein a leading edge portion of the initial duct section comprises an airfoil portion having the same initial value of the geometric parameter as the predetermined airfoil section.

5. The method of claim 1, wherein determining fluid flow paths around the initial duct section when subject to a crosswind having a predetermined crosswind speed comprises determining a flow field.

6. The method of claim 1, wherein the threshold value causes attached fluid flow paths at the windward side at below the predetermined crosswind speed.

7. The method of claim 1, wherein varying the initial value of the geometric parameter of the initial duct section varies a curvature of a leading edge portion of the initial duct section, and wherein the threshold value defines a specific curvature of the leading edge portion of the initial duct section.

8. The method of claim 7, wherein varying the initial value of the geometric parameter of the initial duct section increases the curvature of the leading edge portion of the initial duct section.

9. The method of claim 6, further comprising determining fluid flow paths around the improved duct section at below the predetermined crosswind speed to determine that fluid flow paths are attached.

10. The method of claim 1, wherein the geometric parameter comprises a measure of curvature.

11. The method of claim 10, wherein the measure of curvature comprises a thickness to chord ratio.

12. The method of claim 1, further comprising measuring the initial value of the geometric parameter of the predetermined airfoil section.

13. An apparatus comprising:
at least one processor; and
at least one memory including computer program code;
the at least one memory and the computer program code configured to, with the at least one processor, cause the apparatus at least to:
define an initial duct section free of added flow controllers based on a predetermined airfoil section having an initial value of a geometric parameter such that the geometric parameter of a portion of the initial duct section has the initial value;
determine fluid flow paths around the initial duct section when subject to a crosswind having a predetermined crosswind speed; and
vary the initial value of the geometric parameter of the initial duct section to a threshold value which causes separation of fluid flow paths at a windward side of the initial duct section at and above the predetermined crosswind speed to form an improved duct section corresponding to the predetermined crosswind speed.

14. The apparatus of claim 13, further comprising a measuring device configured in use to receive geometric data of the predetermined airfoil section, the measuring device being adapted to determine the initial value of the geometric parameter of the predetermined airfoil section based on the received geometric data.

15. A system for improving crosswind stability of a propeller duct, the system comprising:
means for defining an initial duct section free of added flow controllers based on a predetermined airfoil section having an initial value of a geometric parameter such that the geometric parameter of a portion of the initial duct section has the initial value;
means for determining fluid flow paths around the initial duct section when subject to a crosswind having a predetermined crosswind speed; and
means for varying the initial value of the geometric parameter of the initial duct section to a threshold value which causes separation of fluid flow paths at a windward side of the initial duct section at and above the predetermined crosswind speed to form an improved duct section corresponding to the predetermined crosswind speed.

16. The system of claim 15, further comprising means for receiving geometric data of the predetermined airfoil section and determining the initial value of the geometric parameter of the predetermined airfoil section based on the received geometric data.

17. A computer readable storage medium having stored thereon computer program code for instructing a computer processor to execute the method of claim 1.
